(19) United States
(12) Patent Application Publication
(10) Pub. No.: US 2013/0325387 A1
(43) Pub. Date: Dec. 5, 2013

(54) SHAPE SENSING DEVICE-SPECIFIC

(71) Applicants: Robert Manzke, Sleepy Hollow, NY (US); Raymond Chan, San Diego, CA (US); Christopher Stephen Hall, Hopewell Junction, NY (US); Bharat Ramachandran, Morganville, NJ (US)

(72) Inventors: Robert Manzke, Sleepy Hollow, NY (US); Raymond Chan, San Diego, CA (US); Christopher Stephen Hall, Hopewell Junction, NY (US); Bharat Ramachandran, Morganville, NJ (US)

(73) Assignee: KONINKLIJKE PHILIPS N.V., EINDHOVEN (NL)

(21) Appl. No.: 13/980,056

(22) PCT Filed: Jan. 20, 2012
(86) PCT No.: PCT/IB12/50273

§ 371 Date: Jul. 17, 2013

Related U.S. Application Data
(60) Provisional application No. 61/436,720, filed on Jan. 27, 2011.

(51) Int. Cl. G01D 18/00; G01B 9/00

(52) U.S. Cl. CPC G01D 18/008; G01B 9/00
USPC 702/97

(57) ABSTRACT

A medical instrument, system and method for calibration are provided. The instrument includes a body (202) and a shape sensing system (204) coupled to the body to permit determination of a shape of the body. A memory element (205, 206) is coupled to the body and configured to store data associated with calibration of the body, the data being readable through a cable (210) connectable to the body so that the data permits calibration of the body.

This disclosure relates to medical devices and methods and more particularly to a calibration system and method which includes device specific data stored in memory elements associated with or integrated on a medical instrument.

Optical shape sensing (OSS) includes distributed strain measurement in optical fiber with characteristic Rayleigh scatter patterns. Rayleigh scatter occurs as a result of random fluctuations of the index of refraction in the fiber core, inherent to the fiber manufacturing process. These random fluctuations can also be modeled as a Bragg grating with a random variation of amplitude and phase along the grating length. If strain or temperature change is applied to the optical fiber, the characteristic Rayleigh scattering pattern changes.

An optical measurement can be performed first with no strain/temperature stimulus applied to the fiber to produce a reference scatter pattern and then again after induction of strain/temperature. Cross-correlation of the Rayleigh scatter spectra of the fiber in the strained/unstrained states determines the spectral shift resulting from the applied strain. This wavelength Δλ or frequency shift Δv of the backscattered pattern due to temperature change ΔT or strain ε along the fiber axis is very similar to the response of a fiber Bragg grating:

$$\frac{Δ λ}{λ} = - \frac{Δ v}{v} = {K}_{T} Δ T + {K}_{ɛ} ɛ ,$$

where the temperature coefficient K_{T} is the sum of the thermal expansion and thermo-optic coefficient. The strain coefficient K_{ε} is a function of group index, n, the components of the strain optic tensor, p_{i,j}, and Poisson's ratio:

$${K}_{ɛ} = 1 - \frac{{n}_{eff}^{2}}{2 ( {p}_{12} - v ( {p}_{11} + {p}_{12} ) )} .$$

Thus, a shift in temperature or strain is merely a linear scaling of the spectral wavelength shift Δλ.

Optical Frequency Domain Reflectometry (OFDR) essentially performs frequency encoding of spatial locations along the fiber which enables distributed sensing of local Rayleigh reflection patterns. In OFDR, the laser wavelength or optical frequency is linearly modulated over time. For coherent detection, the backscattered wave is mixed with a coherence reference wave at the detector. The detector receives a modulated signal owing to the change of constructive to destructive interference and vice versa while scanning the wavelength. Its frequency Ω marks the position s on the fiber and its amplitude is proportional to the local backscattering factor and the total amplitude attenuation factor of forward plus backward propagation through the distance s. By performing a Fourier transform of the detector signal using, for example, a spectrum analyzer, this method allows for simultaneous recovery of the backscattered waves from all points s along the fiber. Thus, strain on different portions of the fiber can be determined by measuring spectral shifts of the characteristic Rayleigh scattering pattern using any number of shift-detection or pattern-matching methods (e.g., block-matching with cross-correlation or other similarity metric, computation of signal phase change, etc.) in combination with OFDR.

A shape sensing device can be built using the above distributed strain measurement methodology when either two or more optical fibers are in a known spatial relationship such as when integrated in a multi-core shape sensing fiber. Based on a reference shape or location with reference Rayleigh scatter patterns (or reference strains), new shapes can be reconstructed using relative strains between fibers in a known/given/fixed spatial relationship.

OSS systems based on Rayleigh scattering depend on accurate determination of the scatter pattern and fiber geometry information (e.g., helical pitch) in known preset positions. It would be advantageous to have such fiber specific calibration scatter patterns available at the time of device usage.

In accordance with the present principles, a medical instrument, system and method for calibration are provided. The instrument includes a body and a shape sensing system coupled to the body to permit determination of a shape of the body. A memory element is coupled to the body and configured to store data associated with calibration of the body, the data being readable through a cable connectable to the body so that the data permits calibration of the body.

A system for calibrating a medical instrument includes a processor and memory storage coupled to the processor. An optical sensing module is configured to receive optical feedback from a shape sensing system coupled to a body of a medical instrument to permit determination of a shape of the body. The medical instrument includes a memory element coupled to the body and configured to store data associated with calibration of the body, the data being readable through a cable coupled from the body to provide the optical feedback to the optical sensing module so that the data permits calibration of the body.

A method includes providing an optical shape sensing medical instrument having a body, a shape sensing system coupled to the body to permit determination of a shape of the body, and a memory element coupled to the body and configured to store device-specific data associated with calibration of the body, the data being readable through a cable connectable to the body so that the data permits calibration of the body. The data associated with calibration of the body is retrieved from the memory element, the data including one of calibration data or reference data pointing to the calibration data. The body of the instrument is calibrated by employing the data associated with calibration of the body.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

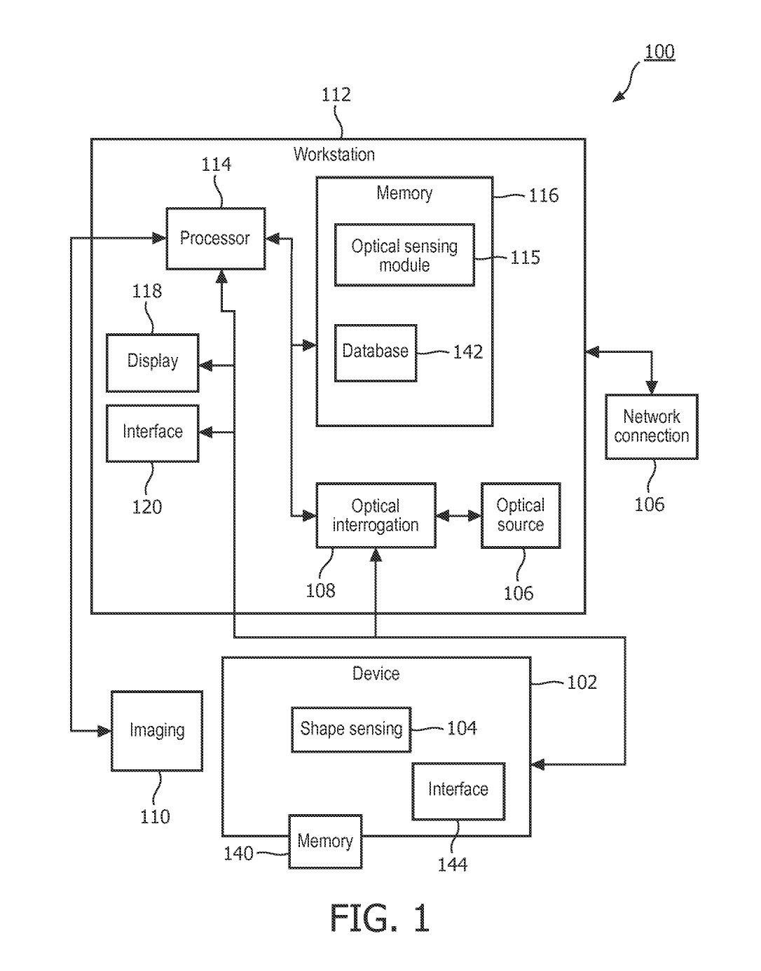

FIG. 1 is a block/flow diagram showing a system/method for calibrating an instrument having optical shape sensing, the instrument including a memory element in accordance with the present principles;

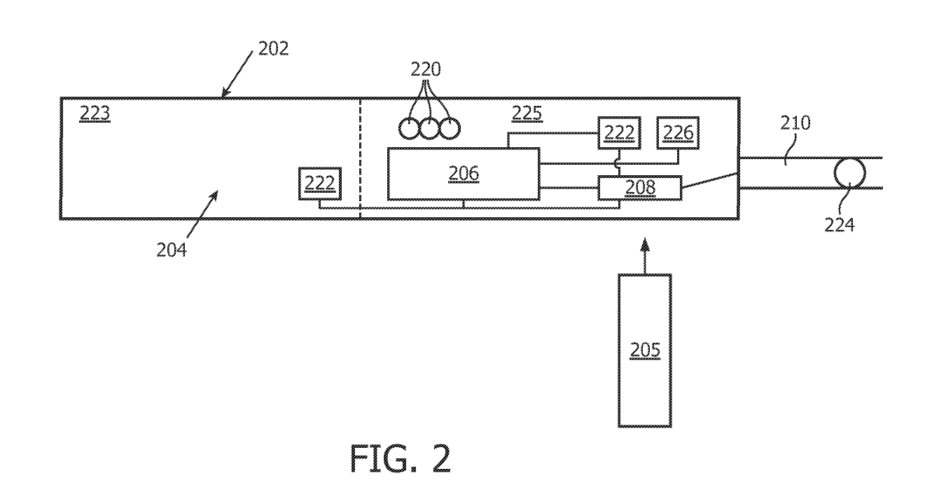

FIG. 2 is a diagram showing an instrument having a memory element for storing calibration data or providing reference data for retrieving the calibration data in accordance with an illustrative embodiment; and

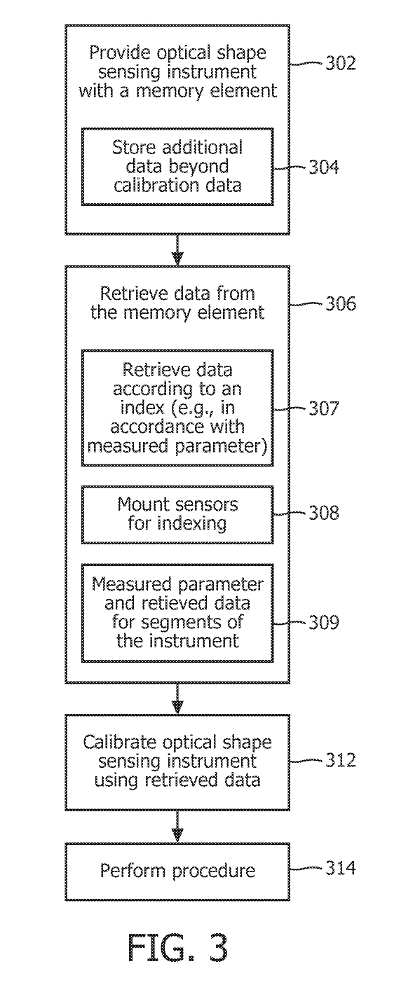

FIG. 3 is a block/flow diagram showing a system/method for calibrating an instrument having optical shape sensing, the instrument including a memory element in accordance with the present principles.

The present disclosure describes a fiber optic shape sensing (OSS) system based on Rayleigh scattering that employs an accurate determination of the scatter pattern and fiber geometry information (e.g., helical pitch) in a preset position(s). Calibration scatter pattern(s) are fiber specific and are useful at the time of device usage. The present embodiments provide storage of fiber-optic shape sensing device specific data in memory elements integrated in the device (e.g., within a catheter or other instrument). Alternatively, serial numbers or other information may be read out from the device and on-line data retrieval may be performed to retrieve needed data. Reference data for different temperatures can be stored. For a correct data set selection, temperature sensors in the device may be employed.

It should be understood that the present invention will be described in terms of medical instruments; however, the teachings of the present invention are much broader and are applicable to any instruments employed in tracking or analyzing complex biological or mechanical systems. In particular, the present principles are applicable to internal tracking procedures of biological systems, procedures in all areas of the body such as the lungs, gastro-intestinal tract, excretory organs, blood vessels, etc. The elements depicted in the FIGS. may be implemented in various combinations of hardware and software and provide functions which may be combined in a single element or multiple elements.

The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which may be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Referring now to the drawings in which like numerals represent the same or similar elements and initially to FIG. 1, a system 100 for performing a medical procedure is illustratively depicted. System 100 may include a workstation or console 112 from which a procedure is supervised and managed. Workstation 112 preferably includes one or more processors 114 and memory 116 for storing programs and applications. Memory 116 may store an optical sensing module 115 configured to interpret optical feedback signals from a shape sensing device 104. Optical sensing module 115 is configured to use the optical signal feedback (and any other feedback, e.g., electromagnetic (EM)) to reconstruct deformations, deflections and other changes associated with a medical device 102 and/or its surrounding region. The medical device 102 may include a catheter, a guidewire, a probe, an endoscope, a robot or other active device, etc.

Workstation 112 may include a display 118 for viewing internal images of a subject if an imaging system 110 is employed. The imaging system 110 may include, e.g., a magnetic resonance imaging (MRI) system, a fluoroscopy system, a computed tomography (CT) system, etc. Display 118 may also permit a user to interact with the workstation 112 and its components and functions. This is further facilitated by an interface 120 which may include a keyboard, mouse, a joystick or any other peripheral or control to permit user interaction with the workstation 112.

Workstation 112 includes an optical source 106 to provide optical fibers with light. An optical interrogation unit 108 is employed to detect light returning from all fibers. This permits the determination of strains or other parameters, which will be used to interpret the shape, orientation, etc. of the interventional device 102. The light signals will be employed as feedback to make adjustments to access errors and to calibrate the device 102 or system 100.

Shape sensing device 104 includes one or more fibers which are configured to exploit their geometry for detection and correction/calibration of shape tracking errors. Optical interrogation module 108 works with optical sensing module 115 (e.g., shape determination program) to permit tracking of instrument or device 102. The optical fibers of shape sensing device 104 may be attached to the instrument 102 in a known or predetermined geometry to permit interrogation of tracking errors and calibration.

The shape sensing (OSS) system 104 provides Rayleigh scattering for an accurate determination of a scatter pattern and fiber geometry information (e.g., helical pitch) from preset positions. Instrument 102 includes a memory 140 which stores calibration scatter patterns, which are fiber specific and needed at the time of usage of device 102. In one embodiment, memory 140 provides storage of fiber-optic shape sensing device-specific data. Memory 140 may include a memory chip, such as a read-only memory, flash memory, or other memory type. Memory 140 is preferably integrated in the device 102 (e.g., within a catheter or other instrument), but may include a memory device, e.g., a memory stick, USB, etc. that includes the device-specific data and comes with or is packaged with the device 102. An interface 144 permits the data stored in memory 140 to be transferred to the workstation 112. The interface 144 may also include preset buttons or others switches configured to release data when activated.

In one embodiment, instead of storing all the device-specific data in memory 140, reference data or identifying information, such as, serial numbers, identification numbers, link addresses or other information, which occupies a limited amount of space, may be stored in memory 140. The reference data may be read out from the device 102 and on-line data retrieval may be performed to retrieve a full version of the needed data. The reference data may be dependent on one or more parameters or conditions. For example, conditions may include temperature, pressure, etc. Data for different temperatures, etc. can be stored in memory 140 or in a lookup table or database 142 indexed using the reference data. For a correct data set selection, temperature sensors in the device may be employed. The temperature may be read out with the reference data or employed to look up the appropriate data corresponding to that temperature from memory 140 on the device 102.

In one embodiment, the reference data may be employed to set device configuration or dictate procedural limitations or instructions. For example, shape sensing fibers of shape sensing system 104 may be active for a limited time based on a serial number or calibration data specific for a particular device.

The memory 140 (or database 142) may be employed as a shape sensing database for clinical decision support (CDS) and statistical shape data collection. For many CDS related applications, the information collected during an interventional procedure may be important. For example, in the case of an ablation procedure, it would be advantageous to know the shapes that were used by the clinician, and the time that the interventionalist spent at a particular lesion/site. This information may be collected and stored by the memory 140 (or in database 142). In addition, this information could be saved in online data storage through a network connection 150, and be used for similar cases using various CDS techniques.

Referring to FIG. 2, a medical instrument or device 202, such as a catheter, probe or other device is OSS enabled (using an integrated shape sensing system 204) and includes an integrated memory chip 206 for storing fiber specific data needed for shape reconstruction. The memory chip 206 may include an electronically programmable read only memory (EPROM), or other memory device type. In one embodiment, the medical instrument 202 is packaged with a memory stick 205 or other portable memory device bearing the relevant information which can be inserted into the device 202 to provide a readout to the optical sensing module 115 (or reconstructor unit) or the memory stick 205 may be plugged into the workstation 112 directly. The memory chip 206 and the memory stick 206 will be referred to as a memory element 205, 206 and may be employed together or separately.

The memory element 205, 206 can be used to store or retrieve information from previous shapes of the device 202 in addition to a set of standard reference shapes potentially useful for shape reconstruction. The memory element 205, 206 may be written to using the workstation 112 or may include an application stored in the memory element 205, 206 which is activated by a user to store a configuration.

An electronic read-write mechanism or interface 208 enables the memory chip 206 (or memory stick 205) to output its stored data to cabling 210, or may be activated to enable information (e.g., a current configuration) to be stored in the memory element 205, 206. The cable or cabling 210 outputs the relevant data to the optical sensing module 115 (FIG. 1). Once the data is obtained, a calibration may be carried out for the device 202.

In one embodiment, electronic storage includes reference data, such as a serial number, etc. and online retrieval (e.g. via Internet connection 150 or a database 142 stored in memory 116 (FIG. 1)) may be cross-referenced for relevant calibration data. In another embodiment, the reference data (e.g., serial number) may be entered directly by the user into the workstation 112 for retrieval from the database 142 or for an online retrieval of relevant calibration data using a network connection 150 (FIG. 1).

In another embodiment, the electronic read-out mechanism 208 may include one or more preset switches 220. The present switches 220 may be selected by a user in accordance with a calibration strategy. Each switch 220 may provide a readout of different calibration data for a particular set of conditions. The user selectable calibration preset switches 220 provide uses selectable calibration data or reference data to be read out to the workstation 112 (FIG. 1) from the device memory 206 (or 205).

The memory element 205, 206 may be configured to store and retrieve calibration data sets for multiple temperatures or temperature ranges. In one embodiment, an embedded temperature sensor or a plurality of temperature sensors 222 may be included on device 202. The sensors 222 may be employed to identify a correct temperature calibration data set and provide for dynamic adaptation depending on the temperature. Other parameters, e.g., pressure, may be monitored by appropriate sensors in a similar fashion.

In addition, calibration data or reference data may be stored for a plurality of different segments 223, 225 and the temperatures of these segments 223, 225 may be individually monitored so that different temperatures for different segments can be accounted for in the calibration. For example, in a clinical scenario, the lab temperature may be about 15 deg C. while a patient's body temperature would be at 37 deg C. As a result, the OSS fiber in the device 202 will have a proximal portion at a lower temperature and a distal portion at a higher temperature. This localized variation in temperature should be accounted for and the data stored in the memory element 205, 206. Separate temperature sensors 222 on the optical device 202 may perform temperature measurements that can be employed to select the correct data set or reference data.

In addition to or instead of storing calibration or reference data, the memory element 205, 206 may store other information. In one example, a serial number or code may be stored which can be used to encode a specific image marker 224 arrangement on the cable 210 or device 202. The image marker 224 may be employed in registering images or otherwise defining a position in visual images of a subject (e.g., a patient). The marker code may be in information looked up (per serial number) or actually stored in the memory element 205, 206.

In another example, the memory element 205, 206 may store encoded information that enables enhanced functionality on certain systems. The number of readouts may vary from system to system (e.g., a good/better/best performance based on the number of readout for a given system). In one example, a number of readouts needed per unit length may be stored for a given system. This would allow better performance on higher end systems versus lower performing systems.

In another embodiment, the memory element 205, 206 may include encoded information employed to match other devices or systems to ensure compatibility or to enforce a policy. For example, if only certain real-time integrations are possible, e.g., device 202 may only be useful or compatible for use with a particular endoscope. The memory element 205, 206 may store a key that is complementary with a memory element on the endoscope and stored in the endoscopes memory. The keys stored on each device are checked, e.g., by a workstation or the like to determine if the devices can be employed together. In the present example, the correct match up between keys permits the device 202 (e.g., a catheter) to work within the channel of the endoscope in this example.

The instrument 202 may include an optional vibration sensor 226. The vibration sensor 226 may be employed to detect vibrations in instrument 202 to be read-out during device operation. The vibrations measured are employed to determine data validity of optical fiber signals. It should be understood that the different embodiments described herein for device 202 (device 102) may be employed in any combination.

Referring to FIG. 3, a calibration system/method is illustratively shown in accordance with one embodiment. In block 302, an optical shape sensing medical instrument is provided having a body, a shape sensing system coupled to the body to permit determination of a shape of the body, and a memory element coupled or couplable to the body and configured to store device-specific data associated with calibration of the body, the data being readable through a cable connectable to the body so that the data permits calibration of the body.

The memory element may include a memory chip installed or integrated within the body or a memory stick or equivalent device which is insertable within the body or coupled to the optical sensing module or workstation. In block 304, the memory element may store additional device specific information. For example, the memory element may store at least one of an encoding to indicate compatibility with another device, an encoding to indicate an image marker arrangement, an encoding to indicate a functionality of a system for which the instrument is being employed, a current configuration of the instrument, etc.

In block 306, the data associated with calibration of the body is retrieved from the memory element. The data may include the actual calibration data or reference data pointing to the calibration data. In block 307, the data associated with calibration of the body may be indexed using a parameter-dependent index such that, given a value of a parameter, such as temperature or pressure, parameter-dependent data is retrieved from the memory element or from a cross-reference to an external memory source. In block 308, one or more parameter sensors (temperature sensor) may be mounted on or in the instrument to measure the parameter to provide the parameter-dependent data. The body may include one or more segments, and the sensors may be mounted on or in each segment. The parameter at each segment is measured to provide the parameter-dependent data for each segment in block 309.

In block 312, the body of the instrument is calibrated by employing the data associated with calibration of the body. In block 314, the calibrated instrument is employed in conducting a procedure and, in particular, an interventional procedure.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) no specific sequence of acts is intended to be required unless specifically indicated.

Having described preferred embodiments for devices, systems and methods for specific information storage and retrieval for shape sensing (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims.

Having thus described the details and particularity required by the patent laws, what is claimed and desired protected by Letters Patent is set forth in the appended claims:

1. A medical instrument, comprising:
a body (202);
a shape sensing system (204) coupled to the body to permit determination of a shape of the body;
a memory element (206) coupled to the body and configured to store data associated with calibration of the body, the data being readable from the memory element through a cable (210) connectable to the body so that the data permits calibration of the body.

2. The instrument as recited in claim 1, wherein the memory element includes at least one of a memory chip (206) installed within the body and a portable memory device (205) insertable within the body.

3. (canceled)

4. The instrument as recited in claim 1, wherein the data associated with calibration of the body includes one of device-specific calibration data and reference data providing a cross-reference to an external memory source (116, 150) having the device specific calibration data.

5. The instrument as recited in claim 1, wherein the data associated with calibration of the body is parameter-dependent such that given a value of a parameter, parameter-dependent data is retrieved from one of the memory element (205, 206) and a cross-reference to an external memory source (116, 150), wherein the parameter includes a temperature and temperature-dependent data is retrieved from one of the memory element and a cross-reference to an external memory source.

6. (canceled)

7. (canceled)

8. The instrument as recited in claim 4, wherein the body includes one or more segments (223, 225), and at least one temperature sensor (222) configured to provide the temperature-dependent data, the at least one temperature sensor (222) includes at least one temperature sensor mounted on or in each segment and configured to measure the temperature at each segment to provide the temperature-dependent data for each segment.

9. The instrument as recited in claim 1, further comprising one or more preset devices (220) mounted on or in the instrument, the one or more preset devices configured to provide, when activated, data specifically associated with calibration for that preset device and retrieved from one of the memory element and a cross-reference to an external memory source.

10. (canceled)

11. (canceled)

12. (canceled)

13. A system for calibrating a medical instrument, comprising:
a processor (114);
memory storage (116) coupled to the processor;
an optical sensing module (115) configured to receive optical feedback from a shape sensing system (104) coupled to a body of a medical instrument (102) to permit determination of a shape of the body;
the medical instrument further comprising:
a memory element (140) coupled to the body and configured to store data associated with calibration of the body, the data being readable from the memory element through a cable coupled from the body to provide the optical feedback to the optical sensing module so that the data permits calibration of the body.

14. The system as recited in claim 13, wherein the memory element (140) includes one of a memory chip (206) installed within the body and a portable memory device (205) insertable within the body or the optical sensing module.

15. The system as recited in claim 13, wherein the data associated with calibration of the body includes one of device-specific calibration data and reference data providing a cross-reference to the memory storage or an external memory source having the device specific calibration data.

16. The system as recited in claim 13, wherein the data associated with calibration of the body is parameter-dependent such that given a value of a parameter, parameter-dependent data is retrieved from one of the memory element and a cross-reference to the memory storage or an external memory source, wherein the parameter includes a temperature and temperature-dependent data is retrieved from one of the memory element and a cross-reference to the memory storage or an external memory source.

17. (canceled)

18. (canceled)

19. The system as recited in claim 16, wherein the body includes one or more segments (223, 225), and at least one temperature sensor (222) configured to provide the temperature-dependent data, the at least one temperature sensor includes at least one temperature sensor mounted on or in each segment and configured to measure the temperature at each segment to provide the temperature-dependent data for each segment.

20. The system as recited in claim 13, further comprising one or more preset devices (220) mounted on or in the instrument, the one or more preset devices configured to provide, when activated, data specifically associated that preset device for calibration and retrieved from one of the memory element and a cross-reference to the memory storage or an external memory source.

21. (canceled)

22. (canceled)

23. (canceled)

24. A method, comprising:
providing (302) an optical shape sensing medical instrument having a body, a shape sensing system coupled to the body to permit determination of a shape of the body, and a memory element coupled to the body and configured to store device-specific data associated with calibration of the body, the data being readable from the memory element through a cable connectable to the body so that the data permits calibration of the body;
retrieving (306) the data associated with calibration of the body from the memory element, the data including one of calibration data or reference data pointing to the calibration data; and
calibrating (312) the body of the instrument by employing the data associated with calibration of the body.

25. (canceled)

26. The method as recited in claim 24, wherein retrieving (306) includes indexing (307) the data associated with calibration of the body using a parameter-dependent index such that given a value of a parameter, parameter-dependent data is retrieved from one of the memory element and a cross-reference to an external memory source.

27. (canceled)

28. The method as recited in claim 24, wherein the body includes one or more segments, and the at least one temperature sensor includes at least one temperature sensor mounted on or in each segment and further comprising measuring (309) the temperature at each segment to provide the temperature-dependent data for each segment.

29. (canceled)

30. (canceled)
